(19) United States
(12) Patent Application Publication
(10) Pub. No.: US 2005/0279573 A1
(43) Pub. Date: Dec. 22, 2005

(54) Greened sound-absorbing structure

(76) Inventors: Francesco Ferraiolo, Ca' de' Fabbri (Bologna) (IT); Stefano Zelari, Pistoia (IT)

Correspondence Address: FLYNN THIEL BOUTELL & TANIS, P.C., 2026 RAMBLING ROAD, KALAMAZOO, MI, 49008-1631, US

(21) Appl. No.: 11/154,277

(22) Filed: Jun. 16, 2005

(30) Foreign Application Priority Data
Jun. 17, 2004 (IT) BO2004A000380

(51) Int. Cl. E04B 1/00; E04B 9/00; E04H 17/00; G10K 11/00; B64F 1/26

(52) U.S. Cl. 181/285; 181/210

(57) ABSTRACT

A modular greened sound-absorbing structure is formed by one or more containment sections (2, 4, 6, 8, 10, 12) for filling material in which plant material can be cultivated. Each containment section comprises frame means (20), connecting means (30, 32) engaged with the frame means in order to connect those frame means to one another, and a plurality of wall means (40) engaged with the frame means in such a manner as to define at least one pair of lateral walls of one of the above-mentioned containment sections. Finally, the containment sections are filled completely with the filling material.

The present invention relates to the sector of greened sound-absorbing structures which are located in open surroundings and erected in situ and which are used to protect areas from sources of very loud noise, such as, for example, areas in the vicinity of roads, motorways, railways and airports.

The invention was developed with particular regard to a greened sound-absorbing structure comprising one or more containment sections for filling materials and components, each containment section comprising frame means, and a plurality of netting panels defining at least one pair of lateral walls of the containment section. The filling materials and components are particularly suitable for supporting a development of herbaceous, shrub and suffruticous plant species such as to produce a covering of vegetation on the barrier.

Structures for acoustic protection of the known type include various solutions which tend to interpose between the source of the noise and the area to be protected a rigid barrier which attenuates the noise by reflecting and/or deflecting the sound waves. These structures are usually heavy, difficult to handle, extremely expensive and have an excessively high environmental impact. Other types of protective barrier comprise lighter and more flexible structures which are capable of absorbing the shock waves and on which greenery improving the environmental impact is provided. However, these last-mentioned structures have some problems, which include the production and maintenance of the vegetation component.

An object of the present invention is to produce a vegetative sound-absorbing structure which is capable of overcoming the disadvantages of the prior art and of attenuating and absorbing the sound waves very efficiently and which, for the support and development of the covering of vegetation, is characterized by a limited environmental impact, and which is also associated with qualities of durability and ease of management. A further object of the present invention is to provide a vegetative sound-absorbing structure which is substantially modular with the result that it is readily adaptable to the environmental and morphological conditions of the area in which it is to be erected, which has a minimum environmental impact and which permits the accommodation of numerous varieties of plants and shrubs, above all of medium dimensions, in conformity with the surrounding environment.

A further object of the present invention is to provide a greened sound-absorbing structure which is economical, easy to maintain and install and which has a high degree of strength even after prolonged use, maintaining unaltered over time the appropriate characteristics for supporting the covering of vegetation correctly.

In order to achieve the objects indicated above, the invention relates to a vegetative sound-absorbing structure as defined in the main claim which follows. The invention relates also to a process and a kit for producing and erecting a vegetative sound-absorbing structure, having the features indicated in the claims which follow.

One of the main advantages of the present invention is the fact that the lateral walls of the containment sections comprise an electrically welded netting composed of double horizontal wires and single vertical wires. This solution enables lateral walls to be obtained which comprise openings of a large size such as to permit the planting and, subsequently, the growth of various types of plant, in particular shrubs and bushes having various vegetative habiti, for example shrubs having small and medium dimensions. This solution also makes it possible to produce lateral containment walls having a high coefficient of overall rigidity in order to be able to fill the entire sound-absorbing structure with filling material, avoiding bulging phenomena and containing the filling material adequately. A consequent advantage of this solution is that the plants planted on the sound-absorbing structure of the present invention have available to them large quantities of filling material, for example, soil, mixtures of artificial soil and other similar elements. This makes a considerable contribution to the growth of the above-mentioned shrubs and bushes having various vegetative habiti, and, above all, to the growth of shrubs of small and medium dimensions.

A further advantage of the present invention consists in the possibility of modifying the design and shape of the vegetative sound-absorbing structure by varying the dimensions of the containment sections of which it is composed. It is thus possible to produce a structure which comprises not only inclined lateral walls but also inclined upper end portions, promoting greening and reducing the environmental impact.

A further advantage of the present invention is provided by the fact that the sound-absorbing structure is composed of a plurality of containment modules or sections which can be assembled progressively and differently with respect to one another in such a manner as readily to vary the dimensions and/or the shape of the structure both in the design stage on the basis of predetermined environmental characteristics and in the course of erection on the basis of unforeseen events.

Further features and advantages will emerge from the following description with reference to the appended Figures which are given purely by way of non-limiting example, in which:

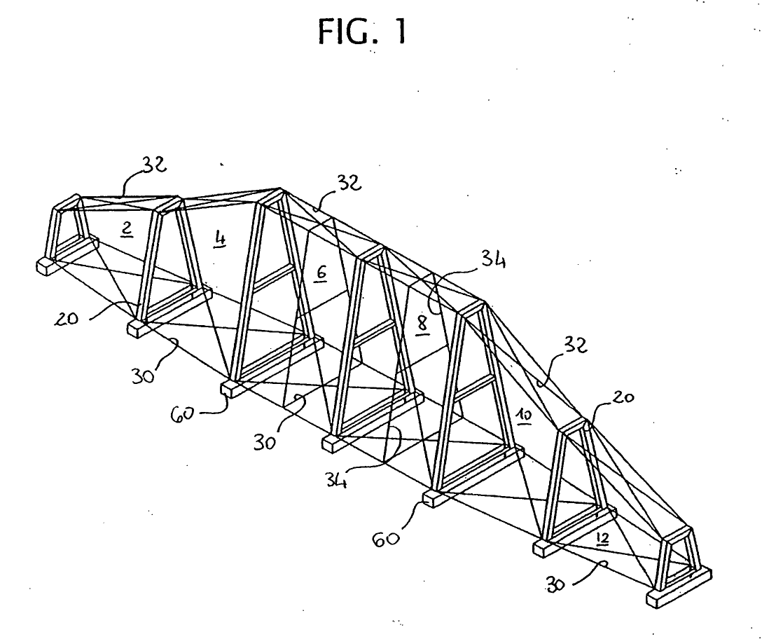

FIG. 1 is a diagrammatic perspective view of the bearing structure of a greened sound-absorbing structure according to the present invention;

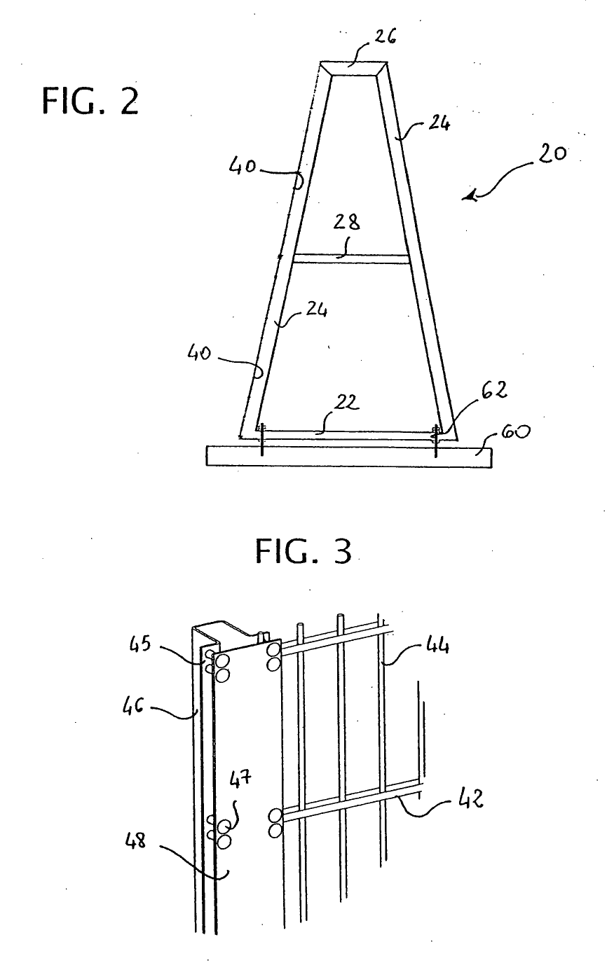

FIG. 2 is a front view of a support frame;

FIG. 3 is a partial perspective view of the system for connecting the netting panels to the support frames;

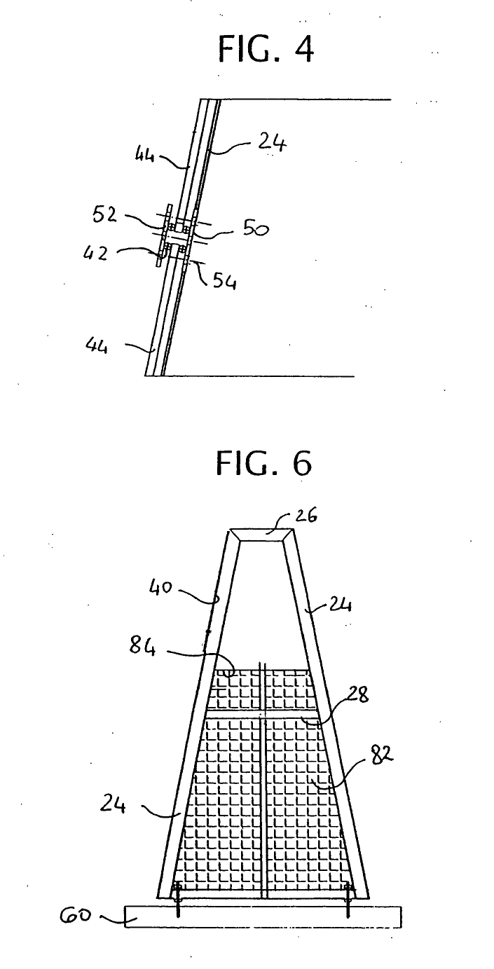

FIG. 4 is a diagrammatic sectioned view of the connection component of an element for reinforcing the netting panels;

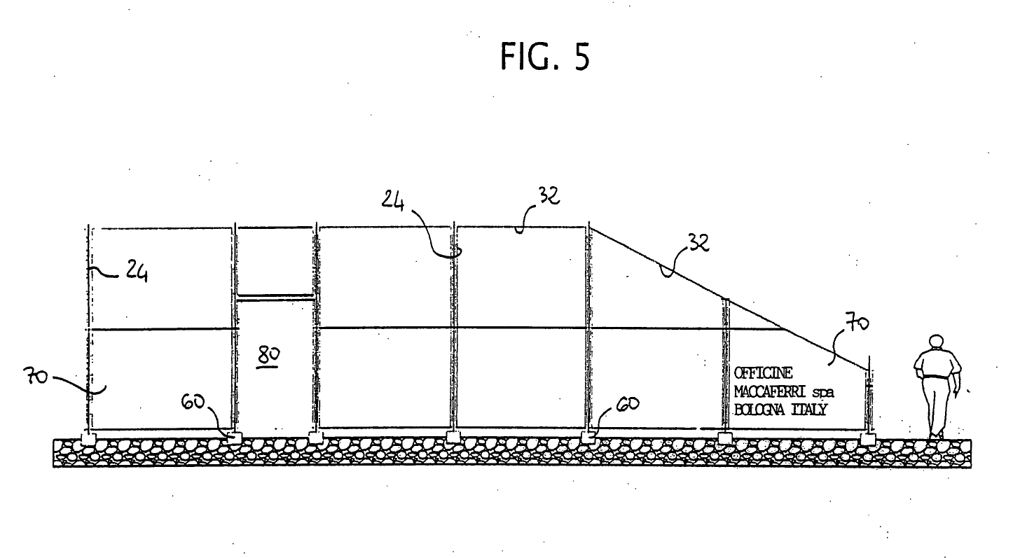

FIG. 5 is a side view of an embodiment of the sound-absorbing structure according to the present invention; and

FIG. 6 is a front view of an inner wall of the passage region of a sound-absorbing structure according to the present invention.

Referring now to FIGS. 1 and 2, a modular greened sound-absorbing structure according to the present invention comprises a plurality of containment sections (2, 4, 6, 8, 10, 12) which are disposed side by side in accordance with a preferred direction and which are connected to each other. Each containment section comprises frame means, for example, although this does not constitute a limitation, a pair of support frames (20), preferably in the shape of an isosceles trapezium, each comprising a base portion (22), two lateral uprights (24) and an upper portion (26). The frames, which are preferably produced using metal material, are connected to each other by connection means, optionally base (30) and top (32) wind-braces and cross-members, which are preferably produced using metal straps or reinforcing rods secured to the support frames, for the purpose of stabilising the containment sections both during the installation stage and during prolonged use. On the basis of some experiments carried out by the Applicant, and purely by way of example, the distance between the pairs of frames of the central portion of the structure may preferably be from 2 to 3 metres, even more preferably approximately 2.5 metres, while the distance between the end frames may be slightly smaller, preferably approximately 2 metres.

Each containment section, preferably the central sections, can be reinforced by first reinforcing means, such as, for example, frame structures of light material or further wind-braces and cross-members (34), which are likewise preferably produced using metal straps or reinforcing rods.

As illustrated, the end containment sections (2, 4, 10, 12) of the greened sound-absorbing structure comprise frames (20) of progressively lower height compared with those of the central containment sections (6, 8). FIG. 1 illustrates, still purely by way of example, a sound-absorbing structure which has support frames for the central containment sections-(6, 8) having a height of approximately 3.2 metres and a base of approximately 2 metres, and frames for the end sections (2, 12) having a height of approximately 1.8 metres and a base of likewise approximately 2 metres. Thus it is possible to produce a sound-absorbing structure which has downwardly sloping upper end portions, reducing the environmental impact and, as will be seen more clearly hereinafter, promoting the greening of the structure.

A person skilled in the art could of course define forms and geometries, such as, for example, triangular, parallelepipedal, cylindrical or frustoconical, or dimensions, height and width, for the frame means which differ from those illustrated but which are nevertheless capable of producing containment sections which are able to achieve the same objects and advantages of the present invention and in such a manner as to provide a sound-absorbing structure which can vary its form in order to conform to the environmental and morphological conditions of the area to be protected acoustically, without thereby departing from the scope of the present invention.

The frames of larger dimensions, for example, those of the central portions, may comprise one or more cross-members (28) which are secured, for example, welded, between the two lateral uprights (24) with the aim of compacting, in use, each containment section and reducing the bulging effect of the structure which is caused by the pressure of the containment material.

Each containment section therefore comprises two lateral walls which are produced, for example, using wire netting (40), preferably electrically welded wire netting. According to one of the embodiments of the present invention, which is illustrated in FIG. 3, the electrically welded nettings are composed of double horizontal wires (42) and single vertical wires (44) having a diameter of from 4 to 8 mm. It is thus possible to produce panels of electrically welded netting having meshes of large dimensions, for example, although this does not constitute a limitation, approximately 100×200 mm, while maintaining a high coefficient of overall rigidity of the panel. The high degree of rigidity makes it possible adequately to contain the filling material inside the sound-absorbing structure, while the meshes having large dimensions promote the growth of various plant species, for example, shrubs having small and medium dimensions.

Still as illustrated in FIG. 3, the panels of electrically welded netting are secured to the lateral uprights (24) of each frame (20) by securing means. In particular, each lateral upright (24) is composed of a main structure (46) having a substantially “Ω”-shaped cross-section and of a coupling plate, or casing, (48) which is disposed on the outer portion of the upright (24). In the end portions (45) of the main structure (46) and in the coupling plate (48) are through-holes which are particularly suitable for receiving securing means (47), such as, for example, pins, screws, wedges and the like. In use, the panel (40) of electrically welded netting is moved close to the main structure and then the coupling plate is superposed on the panel in such a manner that the openings formed in the coupling plate are at the location of the openings formed in the main structure. At this point, the securing means are caused to pass through corresponding holes and the netting panel is secured to the frame (20).

In addition, the frames, and in particular the lateral uprights, may have other through-openings produced in accordance with a direction parallel with the plane defined by the electrically welded grids. These openings may be particularly suitable for the passage of further connecting means between adjacent frames, and for laying electrical cables and/or hydraulic ducts used for the management and control of apparatus and devices which are intrinsic and/or connected to the sound-absorbing structure.

As illustrated in FIG. 4, the structure may comprise further reinforcing means, for example, means that are particularly suitable for preventing bulging effects in the lateral walls. The reinforcing means, for example metal bars or other similar elements, are engaged on the two lateral walls of a containment section. According to one particular embodiment, each bar comprises at one or both of its ends a metal plate (50) which has one or more through-holes which are particularly suitable for accommodating securing means. The reinforcing means also comprise a counter-plate (52) whose surface has similar through-holes. In use, the reinforcing bar is positioned inside one of the containment sections in such a manner that its end plates (50) bear on the internal surface of the netting panels (40) of which the lateral walls of the section are composed. The counter-plates (52) are positioned on the external surface of the netting panels (40) at the location of the end plates (50), and in such a manner as to align the through-holes of the end plates with the through-holes of the counter-plates. Securing means (54), for example, although this does not constitute a limitation, pins, screws, wedges and the like, are caused to pass through the holes in order to fasten the two plates together, securing the reinforcing bars to the lateral walls of the containment section. The connection between the reinforcing bars and the panels may of course be produced in accordance with different embodiments, just as it is possible to produce different connecting elements for the two ends of each reinforcing bar.

If the containment sections of the central portion (6, 8) of the sound-absorbing structure comprise frames (20) which have larger dimensions than those of the others, the lateral walls of those sections may each be formed by two panels (40) of electrically welded netting which are secured one on top of the other to the lateral uprights (24) of the support frames (20).

The upper portion of the sound-absorbing structure may likewise comprise panels of wire netting, for example, electrically welded netting, or it may be left open to the sky in order to promote the growth of the vegetation and the greening of the structure.

Preferably, the lower portion (22) of the frames can be engaged with anchoring means in order to improve the vertical attitude, the stability and the maintenance of the position of the sound-absorbing structure. The anchoring means may comprise, for example, a single-stud or double-stud securing system (62) having ties of reinforced concrete (60) or of plain concrete or of another material, or anchoring blocks submerged in the soil, to which the lower portions (22) of the support frames (20) are secured.

In order to improve the greening of the sound-absorbing structure, means for retaining fine particles, such as, for example, a biomat, or one or more mats of geosynthetic material, non-woven geotextile and/or natural fibre, and other similar elements, may be secured to the electrically welded netting. Thus it is possible to prevent the filling material from escaping, without obstructing the passage of water and the normal transpiration of the soil. The filling material is generally composed of hygroscopic material, loam, peat, organic fertilizer, manure and inert materials.

According to one of the embodiments of the present invention, one or more containment sections also comprise metal panels (70), or panels of other materials resistant to atmospheric agents, which are secured to the outside of the electrically welded netting. These panels may comprise advertising inscriptions and/or other information of particular use, such as road signs, information regarding the vegetation of which the sound-absorbing structure is composed and/or geographical and historical information relating to the area to be protected acoustically.

According to another of the embodiments of the present invention, the greened sound-absorbing structure comprises a containment section whose interior has a through-region (80) for safety purposes in order to permit passage from one side of the sound-absorbing structure to the other. As illustrated in FIGS. 5 and 6, a containment section comprises a pair of frames (20) which are connected to each other by the connecting means (30, 32) described above. The internal portions of the frames are closed by protective panels (82) which are secured sealingly to the base portion (22) and to the lateral uprights (24) of the support frames (20). The protective panels (82), which are produced, for example, although this is not to constitute a limitation, using painted sheet zinc, provide a through-region which is free from filling material and which is closed at the two ends by doors which are secured to the support frames. The upper portion of the containment sections comprising the through-region may be left open to the sky, may be closed by a false ceiling (84) comprising a further upper protective panel and/or may comprise a closed portion filled with plant material.

In use, a modular greened sound-absorbing structure according to the present invention is produced by putting in place a plurality of frame means, the number and size of which are predetermined in accordance with the environmental and morphological characteristics of the area to be protected acoustically, and by putting in place a plurality of panels (40) of electrically welded netting.

Two first frames (20) are initially disposed opposite and facing each other, aligned in accordance with a predetermined direction, and are then connected to each other by base (30) and top (32) wind-braces and cross-members. Two panels (40) of electrically welded netting are secured to this first pair of frames in such a manner as to produce the bearing structure of a first containment section (2) of the sound-absorbing structure. Preferably, but not necessarily, the first two frames arranged in alignment are the frames having smaller dimensions which constitute an end containment section of the sound-absorbing structure. Then, a third frame (20) is disposed opposite and facing, and aligned in accordance with the said predetermined direction, one of the first two frames (20) and is connected thereto by further base (30) and top (32) wind-braces and cross-members. Two further panels (40) of electrically welded netting are secured between the second and the third frame in order to create the bearing structure of a second containment section (4) of the sound-absorbing structure. This last-mentioned procedure is repeated until a bearing structure having the desired dimensions and comprising a predetermined number of containment sections is created. Naturally, the number of containment sections may be varied in the course of erection without necessarily having to interfere with the rest of the sound-absorbing structure. Similarly, the size of the following frames may be different from that of the first frames, for example, it may increase progressively, then remain constant, and finally decrease in such a manner as to create, as illustrated in FIG. 1, a bearing structure with containment sections having a smaller space requirement and whose upper portions are inclined outwards in order to facilitate greening.

In addition, this procedure for the modular construction of the sound-absorbing structure enables finished structures which have already been assembled to be modified simply by removing or varying some of the containment sections and substituting them with sections having different dimensions or different wall and frame means.

The frames can be anchored to the ground by one of the anchoring means described above, or by other equivalent anchoring means, temporarily during the installation stage or permanently.

The netting panels (40) may already comprise the means for retaining fine particles or, alternatively, those means may be fitted after the panels (40) have been secured to the frames (20) of the structure.

If the greened sound-absorbing structure comprises a through-region (80), after creating the bearing structure of this section, the lateral (82) and upper (84) protective panels are secured to the two frames which delimit it in such a manner as to define the passage region. The passage region (80) is completed externally, instead of with the electrically welded netting, with closure means which can be opened selectively, such as a door, a sliding panel or other equivalent elements, and which are connected to the two frames which delimit it.

The greened sound-absorbing structure is completed by securing to the outside of the electrically welded netting, metal panels (70) comprising advertising inscriptions and/or other information of particular use.

Naturally, the principle of the invention remaining the same, the forms of embodiment and details of construction may be varied widely with respect to those described and illustrated without thereby departing from the scope of the present invention.

1. A modular greened sound-absorbing structure comprising one or more containment sections (2, 4, 6, 8, 10, 12) for filling material in which plant material can be cultivated, each containment section comprising frame means (20), connecting means (30, 32) engaged with the frame means in order to connect those frame means to one another, and a plurality of wall means (40) engaged with the frame means in such a manner as to define at least one pair of lateral walls of the one or more containment sections, the containment sections being completely filled, in use, with the filling material.

2. A structure according to claim 1, characterized in that the wall means comprise panels (40) of electrically welded netting.

3. A structure according to claim 2, characterized in that the panels of electrically welded netting comprise at least double horizontal wires (42) and single vertical wires (44).

4. A structure according to claim 3, characterized in that the frame means comprise a plurality of support frames (20) having different dimensions.

5. A structure according to claim 4, characterized in that the support frames (20) comprise two lateral uprights (24) including a main structure (46) and a coupling plate (48).

6. A structure according to claim 4, characterized in that the panels of electrically welded netting are secured between the main structure (46) and the coupling plate (48) of the lateral upright (24) of the support frame (20).

7. A structure according to claim 6, characterized in that the main structure (46) of the upright (24) has a substantially “omega”-shaped cross-section.

8. A structure according to claim 1, characterized in that it comprises at least one passage region (80) from one side of the sound-absorbing structure to the other, the said region being located in one of the containment sections (2, 4, 6, 8, 10, 12).

9. A structure according to claim 1, characterized in that it also comprises means (60, 62) for anchoring the structure to the ground, which means are connected to the frame means (20).

10. A structure according to claim 1, characterized in that elements for retaining fines are associated with the wall means.

11. A kit for producing a modular greened sound-absorbing structure according to claim 1, characterized in that it comprises a plurality of wall means (40) which can be engaged with the frame means (20) for the arrangement of one or more containment sections (2, 4, 6, 8, 10, 12) for filling material in which plant material can be cultivated, the wall means comprising means for retaining the filling material, the containment sections being completely fillable, in use, with the filling material.

12. A kit according to claim 11, characterized in that the wall means comprise panels (40) of electrically welded netting.

13. A kit according to claim 12, characterized in that the electrically welded netting comprises at least double horizontal wires (42) and single vertical wires (44).

14. A kit according to claim 11, characterized in that it also comprises connecting means (30, 32) which can be engaged with the frame means (20) in order to connect the frame means to one another and to provide the one or more containment sections (2, 4, 6, 8, 10, 12) for filling material.

15. A process for providing a modular greened sound-absorbing structure, characterized in that it comprises the stages of:
selecting at least one pair of frame means, each comprising a base portion (22), two lateral uprights (24) and an upper portion (26), the lateral uprights comprising a main structure (46) and a coupling plate (48);
selecting at least one pair of netting panels (40) compatible with being engaged with the lateral uprights (24); and
selecting one or more connecting means (30, 32) suitable for being engaged with the frame means.
